(19) United States
(12) Patent Application Publication
(10) Pub. No.: US 2022/0153999 A1
(43) Pub. Date: May 19, 2022

(54) ROOM-TEMPERATURE-CURABLE ORGANOPOLYSILOXANE COMPOSITION AND PROTECTIVE AGENT OR ADHESIVE COMPOSITION FOR ELECTRIC/ELECTRONIC COMPONENTS

(71) Applicant: DOW TORAY CO., LTD., Shinagawa-ku, Tokyo (JP)

(72) Inventor: Kenji OTA, Ichihara-shi, Chiba (JP)

(21) Appl. No.: 17/442,646

(22) PCT Filed: Mar. 8, 2020
(86) PCT No.: PCT/JP2020/011999

§ 371 Date: Sep. 24, 2021

(30) Foreign Application Priority Data
Mar. 29, 2019 (JP) 2019-065808

(51) Int. Cl. C08L 83/04; C08G 77/08; C08G 77/18; C08G 77/16; C08K 5/5419; C08K 5/544; C08K 3/36; C08K 9/04; C08K 5/5435

(52) U.S. Cl. CPC C08L 83/04; C08K 2201/014; C08G 77/18; C08G 77/16; C08K 5/5419; C08K 5/544; C08K 3/36; C08K 9/04; C08K 5/5435; C08L 2203/206; C08L 2205/025; C08L 2205/03; C08K 2201/003; C08K 2201/006; C08G 77/08

(57) ABSTRACT

Provided is: a curable organopolysiloxane composition which is easily cured at room temperature, in addition to having excellent adhesiveness with respect to various base materials, a protectant or adhesive composition of electric/electronic parts including this curable organopolysiloxane composition, as well as an electric/electronic equipment wherein electric/electronic parts are encapsulated or sealed by these curable organopolysiloxane compositions. A room temperature curable organopolysiloxane composition of a multicomponent type which is individually stored, including: (A) a diorganopolysiloxane blocked at a molecular terminal with a hydroxysilyl group; (B) a diorganopolysiloxane blocked at a molecular terminal with an alkoxysilyl group; (C) a functional filler; (D) a compound having two or more alkoxy groups bonded to a silicon atom per molecule; and (E) a catalytic amount of a catalyst for a condensation reaction.

### TECHNICAL FIELD

The present invention relates to a curable organopolysiloxane composition which is easily cured at room temperature, in addition to having excellent adhesiveness with respect to various base materials, and further relates to a protectant or adhesive composition of electric/electronic parts including this curable organopolysiloxane composition, as well as to electric/electronic equipment wherein electric/electronic parts are encapsulated or sealed by these curable organopolysiloxane compositions.

### BACKGROUND ART

While curable organopolysiloxane compositions are widely used as protectant compositions of electric/electronic parts, in terms of their reliability and durability as protective materials, they are required to exhibit excellent self-adhesiveness to the base materials with which they come into contact during curing. For example, Patent Document 1 proposes a hydrosilylation reaction curing curable organopolysiloxane composition containing an organopolysiloxane having a specific alkoxysilyl group and alkenyl group per one molecule, which has excellent adhesiveness to uncleaned aluminum die casts, etc. and is cured by heating at approximately 100° C. Moreover, the same document describes that a titanium compound, etc. can be used as an adhesion promoting catalyst. Unfortunately, the curable organopolysiloxane composition is a hydrosilylation reaction curing composition and is not cured if not heated at approximately 100° C., so the adhesiveness thereof to various base materials still has room for improvement. Moreover, if a metal cutting oil including an amine compound, etc., which is a curing inhibitor, remains on the coating surface, curing failures problematically occur.

In contrast, as a room temperature curable silicone rubber composition which is cured at room temperature upon contacting moisture in the air and exhibits good adhesiveness to the base materials with which it comes into contact during curing, Patent Document 2 proposes a room temperature curable silicone rubber composition which includes a diorganopolysiloxane having a specific alkoxysilyl group such as a trimethoxysilylethyl containing group, an organopolysiloxane not having this alkoxysilyl group and a hydroxyl group, an alkoxysilane (serving as a crosslinking agent) or a hydrolysate thereof, and a catalyst for a condensation reaction. Unfortunately, the room temperature curable silicone rubber composition according to Patent Document 2 has insufficient curing speed at room temperature, with there being still room for improvement in terms of adhesion to various substrates.

### PRIOR ART DOCUMENTS

### Patent Documents

Patent Document 1: Japanese Unexamined Patent Application Publication No. 2006-348119
Patent Document 2: Japanese Unexamined Patent Application Publication No. 2012-219113

### SUMMARY OF THE INVENTION

### Problems to be Solved by the Invention

The present invention has been created in order to solve the abovementioned problem, with an object of providing a curable organopolysiloxane composition which is different from conventional curable organopolysiloxane compositions and easily cured at room temperature, has excellent initial adhesiveness to various base materials with which it comes into contact during curing, particularly to organic resins such as an uncleaned aluminum die cast, polybutylene terephthalate (PBT) resin, and polyphenylene sulfide (PPS) resin, and achieves high adhesive strength after curing.

Specifically, an object of the present invention is to provide a protectant or adhesive composition of electric/electronic parts (through the use of the curable organopolysiloxane composition) which is cured at room temperature, has excellent initial adhesiveness and adhesive durability to aluminum die casts and resin material, and can maintain the reliability/durability of electric/electronic parts for extended periods of time. Moreover, an object of the present invention is to provide such electric/electronic parts having excellent reliability/durability.

### Means for Solving the Problems

As a result of extensive research, the present inventors found that the abovementioned problem can be solved via a room temperature curable organopolysiloxane composition containing the following components (A) to (E), leading to the present invention.

A room temperature curable organopolysiloxane composition, including:
(A) 100 parts by weight of a diorganopolysiloxane blocked at a molecular terminal with a hydroxysilyl group having a viscosity of 20 to 1,000,000 mPa·s at 25° C.;
(B) 50 to 200 parts by mass of a diorganopolysiloxane blocked at a molecular terminal with an alkoxysilyl group having a viscosity of 20 to 1,000,000 mPa·s at 25° C., per 100 parts by mass of component (A);
(C) a functional filler;
(D) 0.1 to 30 parts by mass of a compound having two or more alkoxy groups bonded to a silicon atom per molecule; and
(E) a catalytic amount of a catalyst for a condensation reaction;
further including at least the following liquids (I) and (II), which are individually stored, wherein the liquid (I) component contains components (A) and (C) but does not contain components (B) and (E),
while the liquid (II) component contains components (B), (C), (D), and (E) but does not contain component (A).

Note that the object of the present invention may be achieved by using the curable organopolysiloxane composition as a protectant or adhesive of electric/electronic parts. Similarly, the object of the present invention may also be achieved via the curable organopolysiloxane composition, a method for protecting or adhering electric/electronic parts, or electric/electronic equipment including the cured product of the curable organopolysiloxane composition.

### Effects of the Invention

The room temperature curable organopolysiloxane composition according to the present invention enables the provision of a curable organopolysiloxane composition which is easily cured at room temperature, has excellent initial adhesiveness to various base materials with which it comes into contact during curing, particularly to organic resins such as an uncleaned aluminum die cast, polybutylene terephthalate (PBT) resin, and polyphenylene sulfide (PPS) resin, and achieves high adhesive strength after curing.

Moreover, the use of the room temperature curable organopolysiloxane composition according to the present invention enables the provision of a protectant or adhesive composition of electric/electronic parts which is cured at room temperature, has excellent initial adhesiveness and adhesive durability to aluminum die casts and resin material, and can maintain the reliability/durability of electric/electronic parts for extended periods of time. Moreover, the present invention enables the provision of such electric/electronic parts having excellent reliability/durability.

### MODE FOR CARRYING OUT THE INVENTION

As a result of extensive research in order to achieve the abovementioned object, the present inventors found that a composition having excellent storage stability as well as excellent deep curability can be obtained using a different organopolysiloxane in a liquid (I) component and liquid (II) component, leading to the completion of the present invention. The details will be described hereafter.

Component (A) is the main agent of the abovementioned curable organopolysiloxane composition liquid (I) component and may be a mixture of (A-1), a diorganopolysiloxane blocked at both molecular terminals with hydroxysilyl groups, and (A-2), a diorganopolysiloxane blocked at only one molecular terminal with a hydroxysilyl group.

If component (A) has too much of component (A-2), the strength of the silicone elastomer after curing, along with the adhesion thereof to a substrate, tend to decrease. The mixing ratio is preferably within the range of (A-1):(A-2)=100:0 to 20:80, more preferably within the range of (A-1):(A-2)=100:0 to 60:40, further preferably (A-1):(A-2)=95:5 to 70:30, and most preferably within the range of (A-1):(A-2)=95:5 to 80:20.

Moreover, if the viscosity of component (A) is too low, the strength of the cured silicone elastomer will be low; in contrast, if the viscosity is too high, workability during manufacturing and use will decrease. Therefore, the viscosity at 25° C. is preferably within the range of 20 to 1,000,000 mPa·s, more preferably within the range of 100 to 200,000 mPa·s. Note that if component (A) is a mixture of components (A-1) and (A-2), the viscosity is a viscosity as a mixture.

Component (A-1) is a diorganosiloxane represented by the general formula:

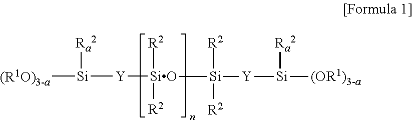

In the formula, R1 is a hydrogen atom and a is 2. R² is a group selected from a monovalent hydrocarbon group, a halogenated hydrocarbon group, and a cyanoalkyl group, with examples thereof including: alkyl groups having 1 to 10 carbon atoms, such as a methyl group, ethyl group, propyl group, butyl group, and octyl group; cycloalkyl groups such as a cyclopentyl group and cyclohexyl group; alkenyl groups such as a vinyl group and allyl group; aryl groups such as a phenyl group, tolyl group, and naphthyl group; aralkyl groups such as a benzyl group, phenylethyl group, and phenylpropyl group; halogenated hydrocarbon groups such as a trifluoropropyl group and chloropropyl group; and cyanoalkyl groups such as a β-cyanoethyl group and γ-cyanopropyl group. Among these, a methyl group is preferable.

Y is an oxygen atom, a divalent hydrocarbon group, or a group represented by the general formula:

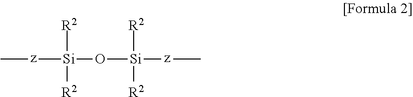

(wherein, R2 is the same as above and Z is a divalent hydrocarbon group.) The divalent hydrocarbon group is preferably an alkylene group having 1 to 10 carbon atoms such as a methylene group, ethylene group, propylene group, butylene group, and hexene group. N is a number such that the viscosity at 25° C. is 20 to 1,000,000 mPa·s.

Component (A-1) can be manufactured by a known method, for example, the method described in JP H3-4566 B and JP S63-270762 A.

Component (A-2) serves to reduce the modulus of the silicone elastomer which is the cured product of the composition according to the present invention, or serves to improve adhesion to a hardly adhesive substrate. Component (A-2) is preferably a diorganosiloxane represented by the general formula:

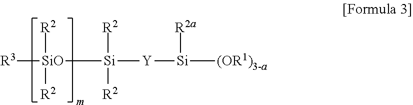

In the formula, R1, R2, Y, and a are the same as described above, while R3 is an alkyl group having 1 to 10 carbon atoms such as a methyl group, ethyl group, propyl group, butyl group, and octyl group; or an alkenyl group such as a vinyl group or allyl group, preferably an alkyl group having 1 to 10 carbon atoms, more preferably a methyl group. m represents a number such that the viscosity at 25° C. is 20 to 1,000,000 mPa·s.

Component (A-2) can be manufactured by a known method, for example, the method described in JP H4-13767 A and JP S63-270762 A.

Component (B) is the main agent of the abovementioned curable organopolysiloxane composition liquid (II) component and may be a mixture of (B-1), a diorganopolysiloxane blocked at both molecular terminals with alkoxysilyl groups, and (B-2), a diorganopolysiloxane blocked at only one molecular terminal with an alkoxysilyl group.

Moreover, if the viscosity of component (B) is too low, the strength of the cured silicone elastomer will be low; in contrast, if the viscosity is too high, workability during manufacturing and use will decrease. Therefore, the viscosity at 25° C. is preferably within the range of 20 to 1,000,000 mPa·s, more preferably within the range of 100 to 200,000 mPa·s. Note that if component (B) is a mixture of components (B-1) and (B-2), the viscosity is a viscosity as a mixture.

Component (B-1) is preferably a diorganosiloxane represented by the general formula:

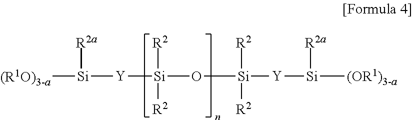

In the formula, R1 is a group selected from alkyl groups having 1 to 10 carbon atoms such as a methyl group, ethyl group, propyl group, butyl group, and octyl group; alkoxy alkyl groups such as a methoxymethyl group, methoxyethyl group, ethoxymethyl group, and ethoxyethoxy group. R2 is a group selected from a monovalent hydrocarbon group, a halogenated hydrocarbon group, and a cyanoalkyl group, with examples thereof including: alkyl groups having 1 to 10 carbon atoms, such as a methyl group, an ethyl group, a propyl group, a butyl group, and an octyl group; cycloalkyl groups such as a cyanoalkyl group and cyclohexyl group; alkenyl groups such as a vinyl group and allyl group; aryl groups such as a phenyl group, tolyl group, and naphthyl group; aralkyl groups such as a benzyl group, phenylethyl group, and phenylpropyl group; halogenated hydrocarbon groups such as a trifluoropropyl group and chloropropyl group; and cyanoalkyl groups such as a β-cyanoethyl group and γ-cyanopropyl group. Among these, a methyl group is preferable. Note that a is 0, 1 or 2.

Y is an oxygen atom, a divalent hydrocarbon group, or a group represented by the general formula:

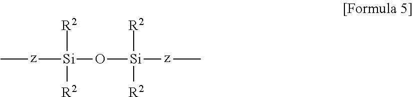

(wherein, R2 is the same as above and Z is a divalent hydrocarbon group.) The divalent hydrocarbon group is preferably an alkylene group having 1 to 10 carbon atoms such as a methylene group, ethylene group, propylene group, butylene group, and hexene group. N is a number such that the viscosity at 25° C. is 20 to 1,000,000 mPa·s.

Component (B-1) can be manufactured by a known method, for example, the method described in JP H3-4566 B and JP S63-270762 A.

Component (B-2) serves to reduce the modulus of the silicone elastomer which is the cured product of the composition according to the present invention, or to improve adhesion to a hardly adhesive substrate. Component (B-2) is preferably a diorganosiloxane represented by the general formula:

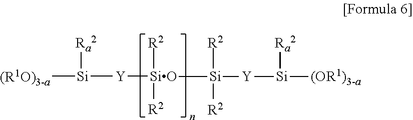

In the formula, R1, R2, Y, and a are the same as described above, while R3 is an alkyl group having 1 to 10 carbon atoms such as a methyl group, ethyl group, propyl group, butyl group, and octyl group; or an alkenyl group such as a vinyl group or allyl group, preferably an alkyl group having 1 to 10 carbon atoms, more preferably a methyl group. m represents a number such that the viscosity at 25° C. is 20 to 1,000,000 mPa·s.

Component (B-2) can be manufactured by a known method, for example, JP H4-13767 A and JP S63-270762 A.

[(C) Functional Filler]

Component (C) is a component which imparts mechanical strength to the present composition or a silicone rubber cured product obtained by curing the present composition, improving the performance thereof as a protectant or adhesive. This functional filler is preferably one or more selected from a reinforcing filler and a conductive filler, preferably containing a reinforcing filler particularly when the present invention composition is used in the application of a protectant or adhesive.

Exemplary reinforcing fillers may include, for example, inorganic fillers such as fumed silica fine powder, precipitated silica fine powder, burned silica fine powder, fumed titanium dioxide fine powder, quartz fine powder, diatomaceous earth fine powder, calcium carbonate fine powder, aluminum oxide fine powder, aluminum hydroxide fine powder, zinc oxide fine powder, and zinc carbonate fine powder, wherein those that do not adversely affect heat resistance are more preferable, and fumed silica fine powder, precipitated silica fine powder, burned silica fine powder, fumed titanium dioxide fine powder, quartz fine powder, and diatomaceous earth powder are optimal. These inorganic fillers may contain inorganic fillers surface treated with treatment agents including organoalkoxysilanes such as a methyltrimethoxysilane, organohalosilanes such as a trimethylchlorosilane, organosilazanes such as a hexamethyldisilazane, and siloxane oligomers such as a dimethylsiloxane oligomer blocked by an α,ω-silanol group, a methylphenylsiloxane oligomer blocked by an α,ω-silanol group, and a methylvinylsiloxane oligomer blocked by an α,ω-silanol group. In particular, by treating the surface of component (C) in advance with an organopolysiloxane of a low degree of polymerization having a silanol group at both terminals of a molecular chain (suitably, a dimethylpolysiloxane blocked with an α,ω-silanol group not having reactive functional groups other than this terminal silanol group in molecules), excellent initial adhesiveness, adhesive durability, and adhesive strength at low temperatures for a short period of time can be achieved, in addition to being able to ensure further sufficient usable time (storage period and handling operation time).

While not particularly limited thereto, the particle diameter of fine powder of the reinforcing filler may be, for example, within the range of 0.01 μm to 1000 μm at the median diameter based on the laser diffraction/scattering type particle size distribution measurement.

The content of the reinforcing filler is not limited, but is within the range of 0.1 to 200 parts by mass per 100 parts by mass of component (A) in the total composition, while the total amount of component (C) in liquids (I) and (II) is within the range of 0.2 to 400 parts by mass.

The thermally conductive filler or the electrically conductive filler is a component which imparts thermal conductivity or electrical conductivity to the silicone rubber cured product obtained by curing the present composition as desired and is exemplified by: a metal fine powder such as gold, silver, nickel, copper, or the like; a fine powder obtained by depositing or plating a metal such as gold, silver, nickel, copper, or the like on the surface of a fine powder such as ceramic, glass, quartz, organic resin, or the like; a metal compound such as aluminum oxide, aluminum nitride, zinc oxide, or the like; and a mixture of two or more of these. Particularly preferable are silver powder, aluminum powder, aluminum oxide powder, zinc oxide powder, aluminum nitride powder, or graphite. When electrical insulation is required for the present composition, a metal oxide powder or a metal nitride powder is preferable, with aluminum oxide powder, zinc oxide powder, or aluminum nitride powder being preferable. Further, the thermally conductive filler or the electrically conductive filler is preferably heated and mixed with the above component (A) at a temperature of 100 to 200° C. under reduced pressure. In particular, component (A) is an organopolysiloxane having an alkoxysilyl containing group, and in some cases, surface treatment of a thermally conductive filler or an electrically conductive filler can provide a composition having low viscosity and excellent handling workability even if it is highly filled.

The average particle diameter of such a thermally conductive filler or an electrically conductive filler is preferably in the range of 1 to 100 μm in terms of median diameter, and particularly preferably in the range of 1 to 50 μm.

[(D) Compound Having Two or More Alkoxy Groups Bonded to a Silicon Atom Per Molecule]

The compound contained in the composition according to the present invention is not particularly limited as long as it is a compound having two or more alkoxy groups bonded to a silicon atom per molecule.

Examples thereof include
(d1) a compound represented by the general formula:

Si(OR¹)ₙR²₄₋ₙ [Formula 7]

(wherein, n is 2, 3, or 4, R¹ is an alkyl group, and R² is an organic group)
having one silicon atom per molecule (wherein, two or more alkoxy groups are bonded to the silicon atom), or a hydrolyzed condensate thereof.

Compound (d1) can have one or more organic groups per molecule.

Exemplary organic groups which can be contained in the silicon compound include hydrocarbon groups which may include at least one type selected from the group consisting of oxygen atoms, nitrogen atoms, and sulfur atoms. Specific examples thereof include an alkyl group (preferably having 1 to 18 carbon atoms), (meth)acrylate group, alkenyl group, aryl group, epoxy group, and combinations thereof. Exemplary alkyl groups include a methyl group, ethyl group, propyl group, and isopropyl group. Exemplary alkenyl groups include a vinyl group, allyl group, propenyl group, isopropenyl group, 2-methyl-1-propenyl group, and 2-methyl allyl group. Exemplary aryl groups include a phenyl group and naphthyl group.

Exemplary compounds (d1) include: dialkoxy silanes such as dimethyldimethoxy silane, dimethyldiethoxy silane, diethyldimethoxy silane, diethyldiethoxy silane, diphenyldimethoxy silane, and diphenyldiethoxy silane; trialkoxy silanes such as methyltrimethoxy silane, methyltriethoxy silane, ethyltrimethoxy silane, ethyltriethoxy silane, phenyltrimethoxy silane, and phenyltriethoxy silane; tetraalkoxy silanes such as tetramethoxy silane, tetraethoxy silane, tetraisopropyloxy silane; hydrolyzate of trialkoxy silane and tetraalkoxysilane; trihydroxy silanes such as methyltrihydroxy silane, ethyltrihydroxy silane, and phenyltrihydroxy silane; tetrahydroxy silane; (meth)acryloxy alkyltrialkoxy silane such as γ-(meth)acryloxy propyltrimethoxy silane, and γ-(meth)acryloxy propyltriethoxysilane; and epoxy group-containing silanes such as 3-glycidoxy prolyltrimethoxy silane, 3-glycidoxy propylmethyldimethoxy silane, 2-(3,4-epoxy cyclohexyl)ethyltrimethoxy silane, and 2-(3,4-epoxy cyclohexyl)ethylmethyldimethoxy silane.

Compound (d2) is an organic compound having at least two alkoxysilyl groups per one molecule, in addition to containing bonds other than a silicon-oxygen bond between these silyl groups, and serves to independently improve initial adhesiveness in addition to improving the adhesive durability to a cured product including this adhesion promoter under harsh conditions, particularly when used in combination with components (d1) and (d3).

In particular, component (d2) is suitably a disilaalkane compound represented by the below-mentioned general formula:

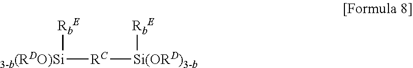

(wherein, R^{C} is a substituted or unsubstituted alkylene group having a carbon number of 2 to 20, R^{D} is each independently an alkyl group or alkoxyalkyl group, R^{E} is each independently a monovalent hydrocarbon group, and b is each independently 0 or 1.) Such component (d2) is commercially available as a reagent or product in various compounds and can be synthesized using a well-known method such as the Grignard reaction or hydrosilylation reaction. For example, component (d2) can be synthesized via a well-known method by the hydrosilylation reaction between diene and trialkoxysilane or organodialkoxysilane.

In the formula, R^{E} is a monovalent hydrocarbon group including: an alkyl group such as a methyl group, ethyl group, and propyl group; an alkenyl group such as a vinyl group or allyl group; and an aryl group such as a phenyl group, with a lower alkyl group preferable. R^{D} is an alkyl group such as a methyl group, ethyl group, and propyl group, or an alkoxyalkyl group such as a methoxyethyl group, preferably having a carbon number of 4 or less. R^{C} is a substituted or unsubstituted alkylene group, with a linear or branched alkylene group used without limitation, and may be a mixture thereof. In terms of improving adhesiveness, a linear and/or branched alkylene group having a carbon number of 2 to 20 is preferable, with a linear and/or branched alkylene having a carbon number of 5 to 10, particularly hexylene having a carbon number of 6, preferable. The unsubstituted alkylene group may be a butylene group, pentylene group, hexylene group, heptylene group, octylene group, nonylene group, decylene group, or a branched structure thereof, with the hydrogen atom capable of being substituted with a methyl group, ethyl group, propyl group, butyl group, cyclopentyl group, cyclohexyl group, vinyl group, allyl group, 3,3,3-trifluoropropyl group, or 3-chloropropyl group.

Specific examples of compound (d2) include bis(trimethoxysilyl)ethane, 1,2-bis(trimethoxysilyl)ethane, 1,2-bis(triethoxysilyl)ethane, 1,2-bis(methyldimethoxysilyl)ethane, 1,2-bis(methyldiethoxysilyl)ethane, 1,1-bis(trimethoxysilyl)ethane, 1,4-bis(trimethoxysilyl)butane, 1,4-bis(triethoxysilyl)butane, 1-methyldimethoxysilyl-4-trimethoxysilylbutane, 1-methyldiethoxysilyl-4-triethoxysilylbutane, 1,4-bis(methyldimethoxysilyl)butane, 1,4-bis(methyldiethoxysilyl)butane, 1,5-bis(trimethoxysilyl)pentane, 1,5-bis(triethoxysilyl)pentane, 1,4-bis(trimethoxysilyl)pentane, 1,4-bis(triethoxysilyl)pentane, 1-methyldimethoxysilyl-5-trimethoxysilylpentane, 1-methyldiethoxysilyl-5-triethoxysilylpentane, 1,5-bis(methyldimethoxysilyl)pentane, 1,5-bis(methyldiethoxysilyl)pentane, 1,6-bis(trimethoxysilyl)hexane, 1,6-bis(triethoxysilyl)hexane, 1,4-bis(trimethoxysilyl)hexane, 1,5-bis(trimethoxysilyl)hexane, 2,5-bis(trimethoxysilyl)hexane, 1-methyldimethoxysilyl-6-trimethoxysilylhexane, 1-phenyldiethoxysilyl-6-triethoxysilylhexane, 1,6-bis(methyldimethoxysilyl)hexane, 1,7-bis(trimethoxysilyl)heptane, 2,5-bis(trimethoxysilyl)heptane, 2,6-bis(trimethoxysilyl)heptane, 1,8-bis(trimethoxysilyl)octane, 2,5-bis(trimethoxysilyl)octane, 2,7-bis(trimethoxysilyl)octane, 1,9-bis(trimethoxysilyl)nonane, 2,7-bis(trimethoxysilyl)nonane, 1,10-bis(trimethoxysilyl)decane, and 3,8-bis(trimethoxysilyl)decane. These can be used independently or as a mixture of two or more types thereof. In the present invention, 1,6-bis(trimethoxysilyl)hexane, 1,6-bis(triethoxysilyl)hexane, 1,4-bis(trimethoxysilyl)hexane, 1,5-bis(trimethoxysilyl)hexane, 2,5-bis(trimethoxysilyl)hexane, 1-methyldimethoxysilyl-6-trimethoxysilylhexane, 1-phenyldiethoxysilyl-6-triethoxysilylhexane, and 1,6-bis(methyldimethoxysilyl)hexane can be suitably exemplified.

Compound (d3) is a reaction mixture between an amino group-containing organoalkoxysilane and an epoxy group-containing organoalkoxysilane. Such compound (d3) is a component for imparting initial adhesiveness to various base materials with which it comes into contact during curing, in addition to imparting adhesiveness at low temperatures particularly to an uncleaned adherend. Moreover, some curing systems of a curable composition obtained by blending this adhesion promoter may act as crosslinking agents. Such a reaction mixture is disclosed in JP S52-8854 B and JP H10-195085 A.

Exemplary alkoxysilanes having an amino group-containing organic group forming such compound (d3) include an aminomethyltriethoxysilane, 3-aminopropyltrimethoxysilane, 3-aminopropyltriethoxysilane, 3-aminopropylmethyldimethoxysilane, N-(2-aminoethyl)aminomethyltributoxysilane, N-(2-aminoethyl)-3-aminopropyltrimethoxysilane, N-(2-aminoethyl)-3-aminopropylmethyldimethoxysilane, and 3-anilinopropyltriethoxysilane.

Moreover, exemplary epoxy groups containing organoalkoxysilanes may include 3-glycidoxyprolyltrimethoxysilane, 3-glycidoxypropylmethyldimethoxysilane, 2-(3,4-epoxy cyclohexyl)ethyltrimethoxysilane, and 2-(3,4-epoxy cyclohexyl)ethylmethyldimethoxysilane.

The ratio of the alkoxysilane having an amino group containing organic group to the alkoxysilane having an epoxy group containing organic group is, in terms of the molar ratio, preferably within the range of (1:1.5) to (1:5), particularly preferably within the range of (1:2) to (1:4). This component (e1) can be easily synthesized by mixing alkoxysilane having an amino group containing organic group and alkoxysilane having an epoxy group containing organic group as mentioned above to cause reaction at room temperature or under heating.

In particular, when an alkoxysilane having an amino group containing organic group is reacted with an alkoxysilane having an epoxy group containing organic group by the method described in JP H10-195085 A, the present invention particularly preferably contains a carbasilatrane derivative obtained by cyclizing and represented by the general formula:

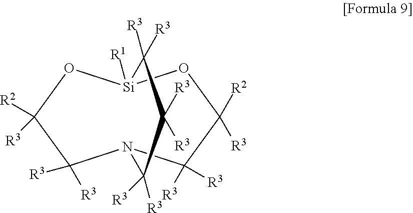

{wherein, R¹ is an alkyl group or an alkoxy group, and R² is the same or different group selected from the group consisting of groups represented by the general formula:

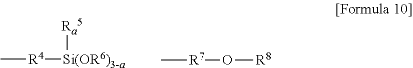

(wherein, R⁴ is an alkylene group or alkyleneoxyalkylene group, R⁵ is a monovalent hydrocarbon group, R⁶ is an alkyl group, R⁷ is an alkylene group, R⁸ is an alkyl group, alkenyl group, or acyl group, and a is 0, 1, or 2.)

R³ is the same or different hydrogen atom or alkyl group.}

Exemplary carbasilatrane derivatives may include a silatrane derivative having an alkenyl group and silicon atom-bonded alkoxy group per one molecule represented by the following structure.

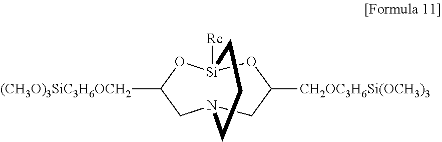

(wherein, R_{C} is a group selected from a methoxy group, ethoxy group, vinyl group, allyl group, and hexenyl group.)

Similarly, in the present invention,

the silatran derivative represented by the following structural formula may be used as the adhesion promoter.

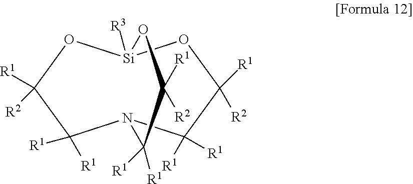

R¹ in the formula is the same or different hydrogen atom or alkyl group, wherein R¹ is particularly preferably a hydrogen atom or a methyl group. In addition, R² in the above formula is the same or different group selected from the group consisting of a hydrogen atom, an alkyl group, and an alkoxysilyl group-containing organic group represented by the general formula: —R⁴—Si(OR⁵)ₓR⁶₍₃₋ₓ₎, provided that at least one R² is this alkoxysilyl group-containing organic group. Exemplary alkyl groups of R² include a methyl group, etc. Moreover, in the alkoxysilyl group-containing organic group of R², R⁴ in the formula is a divalent organic group, with examples thereof including an alkylene group or an alkylene oxyalkylene group, and with an ethylene group, propylene group, butylene group, methyleneoxypropylene group, and methyleneoxypentylene group particularly preferable. Moreover, R⁵ in the formula is an alkyl group having 1 to 10 carbon atoms and is preferably a methyl group or an ethyl group. Moreover, R⁶ in the formula is a substituted or unsubstituted monovalent hydrocarbon group, preferably a methyl group. Moreover, in the formula, x is 1, 2, or 3, preferably 3.

Exemplary such alkoxysilyl group-containing organic groups of R² include the following groups.

### —(CH2)₂Si(OCH3)3-(CH2)2Si(OCH3)2CH3

### —(CH2)3Si(OC2H5)3-(CH2)3Si(OC2H5)(CH3)2

### —CH2O(CH2)3Si(OCH3)3

### —CH2O(CH2)3Si(OC2H5)3

### —CH2O(CH2)3Si(OCH3)2CH3

### —CH2O(CH2)3Si(OC2H5)2CH3

### —CH2OCH2Si(OCH3)3-CH2OCH2Si(OCH3)(CH3)2

R³ in the abovementioned formula is at least one group selected from the group consisting of a substituted or unsubstituted monovalent hydrocarbon group, an alkoxy group having 1 to 10 carbon atoms, a glycidoxyalkyl group, an oxiranylalkyl group, and an acyloxy alkyl group, with exemplary monovalent hydrocarbon groups of R³ including alkyl groups such as methyl groups, exemplary alkoxy groups of R³ including methoxy groups, ethoxy groups, and propoxy groups, exemplary glycidoxy alkyl groups of R³ including 3-glycidoxy propyl groups, exemplary oxiranyl alkyl groups of R³ including 4-oxiranyl butyl groups and 8-oxiranyl octyl groups, and exemplary acyloxy alkyl groups of R³ including acetoxy propyl groups and 3-methacryloxypropyl groups. Specifically, R³ is preferably an alkyl group, alkenyl group, or alkoxy group, and further preferably an alkyl group or alkenyl group, with particularly preferable examples thereof including a group selected from a methyl group, vinyl group, allyl group, and hexenyl group.

Examples of (E) the curing catalyst include: organic acid salts of metals such as tin, titanium, zirconium, iron, antimony, bismuth, and manganese; organic titanate esters; and organic titanium chelate compounds. Specific examples of such a curing catalyst include: dialkyltin dicarboxylic acids such as dimethyltin dilaurate, dimethyl tin dioctoate, dimethyl tin dineodecanoate, dibutyltin dilaurate, dibutyltin dioctoate, and dibutyltin dineodecanoate; organic tin compounds such as stannous octoate; organic titanium compounds such as tetrabutyl titanate, tetraisopropyl titanate, diisopropoxy bis(acetylacetone)titanium, and diisopropoxy bis(ethylacetoacetate) titanium. Among these, in terms of obtaining superior curing properties such as rapid curing properties and deep curability of the composition of the present invention, organotin compounds are preferable, with dialkyl tin dicarboxylic acids preferable among these. The addition amount thereof is preferably within the range of 0.001 to 10 parts by mass, preferably 0.01 to 2.0 parts by mass, with regard to 100 parts by mass of component (A).

The composition of the present invention may contain (F) an aminoalkylmethoxysilane, in addition to the abovementioned components (A) to (E). Exemplary aminoalkyl methoxysilanes include: aminoalkyl organodimethoxysilanes such as γ-aminopropyl methyldimethoxysilanes; aminoalkyl trimethoxysilanes such as γ-aminopropyl trimethoxysilanes; N-(β-aminoalkyl)aminoalkyl organodimethoxysilanes such as N-(β-aminoethyl)aminopropyl methyldimethoxysilanes; N-(β-aminoalkyl)aminoalkyl trimethoxysilanes such as N-(β-aminoethyl)aminopropyltrimethoxysilanes; etc.

[Other Components]

In addition to components (A) to (E), the following other components may be blended as necessary. One type of these other components may be used independently or two or more types may be used in combination. Exemplary optional components include cold resistance imparting agents, flame retardants, pigments, dyes, etc. Moreover, the room temperature curable organopolysiloxane composition of the present invention can, if desired, include one or more types of antistatic agents including known adhesion imparting agents, cationic surfactants, anionic surfactants, or nonionic surfactants; mold release components; thixotropy imparting agents; antifungal agents; heat resistant agents; plasticizers; thixotropy imparting agents; curing accelerators; corrosion inhibitors/migration inhibitors of electrodes and wirings; etc. Moreover, an organic solvent may be added as desired. These additives may be blended into one selected from liquids (I) and (II), and may be added as a separate component when the present composition is designed to be three or more components.

[Method for Manufacturing the Composition]

The room temperature curable organopolysiloxane composition according to the present invention can be prepared by mixing each of the abovementioned components, for example, by mixing components (A) and (C), as well as any other components, in the case of liquid (I). Moreover, the composition can be adjusted by mixing component (C), optionally component (D), such as an alkoxysilane, and treating the surface of component (C) with component (D), then mixing component (A).

In the case of liquid (II), the liquid can be prepared by mixing components (B), (C), and (D), treating the surface of component (C) with component (D), then mixing components (E), (F), and other optional components.

While not particularly limited thereto, exemplary mixing apparatuses as described above may include a single or twin shaft continuous mixer, two rolls, Ross mixer, Hobart mixer, dental mixer, planetary mixer, kneader mixer, Henschel mixer, etc.

[Composition Form and Package]

The room temperature curable organopolysiloxane composition according to the present invention is a multi-component curing composition (including a multi-liquid type, particularly a two-liquid type) which mixes the separated multi-component during use and can be used by mixing multiple individually stored compositions at a predetermined ratio. Note that while not particularly limited thereto, these packages can be selected as desired depending on the curing method, application means, and application object as described below.

[Curability]

The curable organopolysiloxane composition according to the present invention is a condensation reactive and room temperature curable composition, wherein an organopolysiloxane cured product can be formed by a curing reaction mainly involving a condensation reaction with a hydrolysis reaction (specifically, dehydration condensation, deoxime condensation, or dealcoholization condensation) in the presence of moisture within a temperature range of 60° C. or less, suitably 50° C. or less, more suitably room temperature (25° C.) to 50° C. The curing process is not particularly limited, but after mixing each component, the cured product is rapidly cured by contacting moisture in the air at a temperature range of 15 to 50° C. to form an organopolysiloxane cured reaction product having excellent adhesion. Such a cured product exhibits good adhesion to a substrate with which it is in contact during curing, and therefore, exhibits excellent reliability and durability as a protective material without generating gaps or spaces in members.

[Electrical/Electronic Equipment]

The electronic equipment according to the present invention is electronic equipment which includes the abovementioned organopolysiloxane curing reaction product and is closed or sealed by the cured product. The electronic equipment is not particularly limited, with examples thereof including electronic equipment including an electric circuit or electrode, etc. wherein a metal electrode (such as silver, copper, aluminum, or gold) and a metal oxide film electrode (such as ITO (indium tin oxide)) are formed on base materials of glass, epoxy resin, polyimide resin, phenol resin, ceramics, etc. Exemplary such electrodes include: electrodes of liquid crystal displays (LCDs), flat panel displays (FPDs), and flat panel display devices; etc. The present compositions can also be used as coatings for such electrodes. The electronic equipment according to the present invention has good reliability because the organopolysiloxane cured product exhibits high adhesion to a substrate, making it useful for component fixing, in addition to having excellent deep curability.

### EXAMPLES

The present invention will be described below by way of examples; however, the present invention is not limited thereto.

Components (A) to (F) were mixed as follows to obtain curable organopolysiloxane compositions of Examples 1 to 6 and Comparative Examples 1 to 3.

The effects of the present invention were tested as follows.

### [Viscosity]

The viscosity (Pa·s) of the room temperature curable organopolysiloxane composition at 25° C. was determined using a RheoCompass MCR102 (available from Anton Paar GmbH). The geometry was determined using a parallel plate with a diameter of 20 mm and a shear rate value of 10.0 (1/s) at a gap of 100 μm.

### [Evaluation Method of Usable Life of the Room Temperature Curable Thermally Conductive Silicone Composition]

Moreover, the silicone elastomer base composition and the crosslinking agent composition, which are individually stored, were left to stand for 24 hours or more in a curable evaluation temperature atmosphere, then mixed and left to stand under each evaluation temperature atmosphere. The time until the viscosity was lost and the plasticity was expressed when the sample, scooped with a metal spatula, was determined and used as the snap time. Evaluation of the usable life was performed at 25° C.

### [Evaluation Method of Adhesion of the Room Temperature Curable Thermally Conductive Silicone Composition]

The mixture of the room temperature curable silicone elastomer composition was sandwiched between two aluminum test panels (Alumite A5052P) so as to give 1 mm and 100 μm respectively, left to stand under conditions at a temperature of 25±2° C. and a humidity of 50±5%, then cured. The tensile shear adhesive strength of the obtained adhesion test pieces was determined in accordance with the method specified in JIS K 6850:1999 “Adhesives-Determination of tensile lap-shear strength of rigid-to-rigid bonded assemblies” after 7 days.

In the examples, etc. shown below, the following compounds or compositions were used as raw materials. The viscosity is the value determined by a rotary viscometer at 25° C.

### Component (A):

A-1: Dimethylpolysiloxane blocked at the terminal by a hydroxyl group (viscosity: 420 mPa·s, terminal ratio: 85%, 15% trimethylsiloxy group blocked)
A-2: Dimethylpolysiloxane blocked at both molecular terminals with hydroxyl groups (viscosity: 80000 mPa·s)

### Component (B):

[Component (B-1): Organopolysiloxane Having the Following Alkoxysilyl Containing Group represented by the following formula]

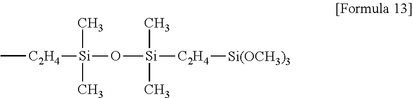

(b1-1) Polysiloxane modified at both terminals: dimethylpolysiloxane having an alkoxysilyl containing group at both terminals of a molecular chain (viscosity: 400 mPa/s)
(b1-2) (Vi) siloxane modified on one terminal: dimethylsiloxane, wherein only one terminal of a molecular chain has an alkoxysilyl containing group, while the other terminal thereof is blocked by a dimethylvinylsiloxy group (viscosity: 400 mPa/s, Vi content of 0.04 mass %)
(b1-3) Vi polysiloxane at both terminals: dimethylsiloxane blocked by a dimethylvinylsiloxy group at both terminals of a molecular chain (viscosity: 400 mPa/s, Vi content: 0.08 mass %)

As mentioned above, components (b1-1) to (b1-3) are mixtures obtained by subjecting the below-mentioned alkoxysilyl containing siloxane to the hydrosilylation reaction with a dimethylsiloxane (viscosity: 400 mPa/s) blocked by a dimethylvinylsiloxy group at both terminals of a molecular chain, in the presence of a catalyst for a hydrosilylation reaction, so as to give a mole equivalent of 0.8 per vinyl group.

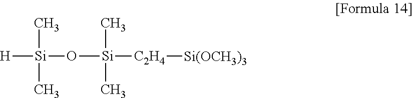

### Component (C):

C-1: Fumed silica surface treated with hexamethyldisilazane (surface area: 130 m²/g)
C-2: Quartz fine powder having an average particle diameter of 4.8 μm

### Component (D)

### D-1: Methyltrimethoxysilane

D-2: 1,6-bis(trimethoxysilyl)hexane
D-3: Carbasilatrane: a silatran derivative represented by the following formula:

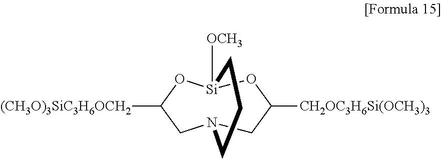

### Component (E):

E-1: Dimethyl tin dineodecanoate

### Component (F):

F-1: N-(2-aminoethyl)3-aminopropyl trimethoxysilane

### Example 1

37.5 parts by mass of component (A-1) and 62.5 parts by mass of component (A-2) were weighed, after which 10 parts by mass of component (C-1) was uniformly mixed therein over the course of 90 minutes to obtain liquid (I) of the room temperature curable organopolysiloxane composition.

Subsequently, 10 parts by mass of component (C-1) was uniformly mixed with 94.5 parts by mass of component (B-1) over the course of 90 minutes. 1.9 parts by mass of component (D-1), 2.0 parts by mass of component (D-2), 0.10 parts by mass of component (E-1), and 1.5 parts by mass of component (F-1) were uniformly mixed in this mixture to obtain liquid (II) of a room temperature curable organopolysiloxane composition.

After the abovementioned room temperature curable organopolysiloxane composition was cured for 7 days at 25° C., the viscosity, usable life, and adhesion were determined after mixing liquids (I) and (II) at the same mass.

### Example 2

Liquids (I) and (II) of the room temperature curable organopolysiloxane composition were obtained as in Example 1, except that component (D-2) of liquid (II) of the room temperature curable organopolysiloxane composition of Example 1 was changed to component (D-3).

After the abovementioned room temperature curable organopolysiloxane composition was cured for 7 days at 25° C., the viscosity, usable life, and adhesion were determined after mixing liquids (I) and (II) at the same mass.

### Example 3

37.5 parts by mass of component (A-1) and 62.5 parts by mass of component (A-2) were weighed, after which 10 parts by mass of component (C-1) was uniformly mixed therein over the course of 90 minutes to obtain liquid (I) of the room temperature curable organopolysiloxane composition.

Subsequently, 10 parts by mass of component (C-1) was uniformly mixed with 94.5 parts by mass of component (B-1) over the course of 90 minutes. 1.9 parts by mass of component (D-1), 3.5 parts by mass of component (D-2), and 0.10 parts by mass of component (E-1) were uniformly mixed in this mixture to obtain liquid (II) of the room temperature curable organopolysiloxane composition.

After the abovementioned room temperature curable organopolysiloxane composition was cured for 7 days at 25° C., the viscosity, usable life, and adhesion were determined after mixing liquids (I) and (II) at the same mass.

### Example 4

80 parts by mass of component (A-1) and 20 parts by mass of component (A-2) were weighed, after which 20 parts by mass of component (C-1) and 80 parts by mass of component (C-2) were uniformly mixed therein over the course of 90 minutes to obtain liquid (I) of the room temperature curable organopolysiloxane composition.

Subsequently, 20 parts by mass of component (C-1) and 80 parts by mass of component (C-2) were uniformly mixed with 95 parts by mass of component (B-1) over the course of 90 minutes. 1.8 parts by mass of component (D-1), 3.0 parts by mass of component (D-2), and 0.20 parts by mass of component (E-1) were uniformly mixed in this mixture to obtain liquid (II) of the room temperature curable organopolysiloxane composition.

After the abovementioned room temperature curable organopolysiloxane composition was cured for 7 days at 25° C., the viscosity, usable life, and adhesion were determined after mixing liquids (I) and (II) at the same mass.

### Example 5

Liquid (I) of the room temperature curable organopolysiloxane composition was obtained as in Example 1.

Subsequently, 20 parts by mass of component (C-1) and 80 parts by mass of component (C-2) were uniformly mixed with 95 parts by mass of component (B-1) over the course of 90 minutes. 4.6 parts by mass of component (D-2) and 0.40 parts by mass of component (E-1) were uniformly mixed in this mixture to obtain liquid (II) of the room temperature curable organopolysiloxane composition.

After the abovementioned room temperature curable organopolysiloxane composition was cured for 7 days at 25° C., the viscosity, usable life, and adhesion were determined after mixing liquids (I) and (II) at the same mass.

### Example 6

Liquids (I) and (II) of the room temperature curable organopolysiloxane composition were obtained as in Example 5, except that component (D-2) of liquid (II) of the room temperature curable organopolysiloxane composition of Example 5 was changed to component (D-3).

After the abovementioned room temperature curable organopolysiloxane composition was cured for 7 days at 25° C., the viscosity, usable life, and adhesion were determined after mixing liquids (I) and (II) at the same mass.

### Example 7

Liquid (I) of the room temperature curable organopolysiloxane composition was obtained as in Example 1.

Subsequently, 20 parts by mass of component (C-1) and 80 parts by mass of component (C-2) were uniformly mixed with 95 parts by mass of component (B-1) over the course of 90 minutes. 0.40 parts by mass of component (E-1) and 1.0 part by mass of component (F-1) were uniformly mixed in this mixture to obtain liquid (II) of the room temperature curable organopolysiloxane composition.

After the abovementioned room temperature curable organopolysiloxane composition was cured for 7 days at 25° C., the viscosity, usable life, and adhesion were determined after mixing liquids (I) and (II) at the same mass.

### Comparative Example 1

Subsequently, 94.5 parts by mass of component (B-1) and 10 parts by mass of component (C-1) were uniformly mixed over the course of 90 minutes. 1.9 parts by mass of component (E-1), 2.0 parts by mass of component (E-2), 0.10 parts by mass of component (E-1), and 1.5 parts by mass of component (F-1) were uniformly mixed in this mixture to obtain a room temperature curable organopolysiloxane composition. After the abovementioned room temperature curable organopolysiloxane composition was cured for 7 days at 25° C., the viscosity, usable life, and adhesion were determined.

### Comparative Example 2

37.5 parts by mass of component (A-1) and 62.5 parts by mass of component (A-2) were weighed, after which 10 parts by mass of component (C-1) was uniformly mixed therein over the course of 90 minutes. 1.9 parts by mass of component (D-1), 2.0 parts by mass of component (D-2), 0.10 parts by mass of component (E-1), and 1.5 parts by mass of component (F-1) were uniformly mixed in this mixture to obtain a room temperature curable organopolysiloxane composition.

After the abovementioned room temperature curable organopolysiloxane composition was cured for 7 days at 25° C., the viscosity, usable life, and adhesion were determined.

### Comparative Example 3

20 parts by mass of component (C-1) and 80 parts by mass of component (C-2) were uniformly mixed with 95 parts by mass of component (B-1) over the course of 90 minutes. 4.6 parts by mass of component (D-2) and 0.40 parts by mass of component (E-1) were uniformly mixed in this mixture to obtain a room temperature curable organopolysiloxane composition.

After the abovementioned room temperature curable organopolysiloxane composition was cured for 7 days at 25° C., the viscosity, usable life, and adhesion were determined.

### Comparative Example 4

80 parts by mass of component (A-1) and 20 parts by mass of component (A-2) were weighed, after which 20 parts by mass of component (C-1) and 80 parts by mass of component (C-2) were uniformly mixed therein over the course of 90 minutes. 4.6 parts by mass of component (D-2) and 0.40 parts by mass of component (E-1) were uniformly mixed in this mixture to obtain a room temperature curable organopolysiloxane composition.

After the abovementioned room temperature curable organopolysiloxane composition was cured for 7 days at 25° C., the viscosity, usable life, and adhesion were determined.

TABLE 1

| | | Example | Example | Example | Example | Example | Example | Example |
|---|---|---|---|---|---|---|---|---|
| | | 1 | 2 | 3 | 4 | 5 | 6 | 7 |
| | | Liquid | Liquid | Liquid | Liquid | Liquid | Liquid | Liquid |
| Component | | (I) | (I) | (I) | (I) | (I) | (I) | (I) |
| A-1 | | 37.5 | 37.5 | 37.5 | 80 | 80 | 80 | 80 |
| A-2 | | 62.5 | 62.5 | 62.5 | 20 | 20 | 20 | 20 |
| C-1 | | 10 | 10 | 10 | 20 | 20 | 20 | 20 |
| C-2 | | | | | 80 | 80 | 80 | 80 |
| | | Liquid | Liquid | Liquid | Liquid | Liquid | Liquid | Liquid |
| | | (II) | (II) | (II) | (II) | (II) | (II) | (II) |
| B-1 | | 94.5 | 94.5 | 94.5 | 95 | 95 | 95 | 95 |
| C-1 | | 10 | 10 | 10 | 20 | 20 | 20 | 20 |
| C-2 | | | | | 80 | 80 | 80 | 80 |
| D-1 | | 1.9 | 1.9 | 1.9 | 1.8 | | | |
| D-2 | | 2.0 | | 3.5 | 3.0 | 4.6 | | |
| D-3 | | | 2.0 | | | | 4.6 | |
| E-1 | | 0.10 | 0.10 | 0.10 | 0.20 | 0.40 | 0.40 | 0.40 |
| F-1 | | 1.50 | 1.50 | | | | | 1.0 |
| Viscosity | (Pa · s) | 39 | 35 | 11 | 44 | 38 | 44 | 196 |
| Usable life | (Time) | 3 | 3 | 8 or | 8 or | 6 | 6 | 2 |
| | | | | more | more | | | |
| Thickness: | Adhesive | 2.8 | 2.1 | 1.8 | 3.1 | 3.7 | 3.8 | 2.4 |
| 100 μm | strength | | | | | | | |
| | (MPa) | | | | | | | |
| | Deformation | 11 | 17 | 12 | 10 | 8 | 10 | 9 |
| | rate (%) | | | | | | | |
| Thickness: | Adhesive | 0.9 | 0.8 | 1.0 | 2.4 | 2.4 | 2.4 | 1.5 |
| 1 mm | strength | | | | | | | |
| | (MPa) | | | | | | | |
| | Deformation | 33 | 49 | 76 | 35 | 22 | 27 | 24 |
| | rate (%) | | | | | | | |

TABLE 2

| | | Comparative | Comparative | Comparative | Comparative |
|---|---|---|---|---|---|
| Component | | Example 1 | Example 2 | Example 3 | Example 4 |
| A-1 | | | 37.5 | | 80 |
| A-2 | | | 62.5 | | 20 |
| B-1 | | 94.5 | | 47.5 | |
| C-1 | | 10 | 10 | 10 | 20 |
| C-2 | | | | 40 | 80 |
| D-1 | | 1.9 | 1.9 | | |
| D-2 | | 2.0 | 2.0 | 2.3 | 4.6 |
| D-3 | | | | | |
| E-1 | | 0.10 | 0.10 | 0.20 | 0.40 |
| F-1 | | 1.50 | 1.50 | | |
| Viscosity | (Pa · s) | 31 | Unmeasurable | 38 | Unmeasurable |
| | | | (gel) | | (gel) |
| Usable life | (Time) | 8 or more | Unmeasurable | 8 or more | Unmeasurable |
| | | | (gel) | | (gel) |
| Thickness: | Adhesive | Uncured | Unable to | Uncured | Unable to |
| 100 μm | strength | | create | | create |
| | (MPa) | | | | |
| | Deformation | | | | |
| | rate (%) | | | | |
| Thickness: | Adhesive | Uncured | Unable to | Uncured | Unable to |
| 1 mm | strength | | create | | create |
| | (MPa) | | | | |
| | Deformation | | | | |
| | rate (%) | | | | |

### Reference Example 1

In the examples, the same properties can be obtained even when component (C) is a fine powder of calcium carbonate. At this time, the effect is obtained even with heavy calcium carbonate fine powder, light calcium carbonate fine powder, and the calcium carbonate thereof surface treated with an organic acid such as a fatty acid or resin acid; however, the heat resistance of these compositions is inferior to other functional fillers, so the application is limited as a protectant composition of electric/electronic parts.

### SUMMARY

As illustrated in Example 1 to 7, the room temperature curable organopolysiloxane composition according to the present invention achieved sufficient working usable life, while adhesive strength was confirmed even in a thin layer with a thickness of 100 μm after 7 days of curing.

In contrast, in Comparative Examples 1 and 3, which lacked component (a) of the present invention, curing was not confirmed even after 7 days. Moreover, in Comparative Examples 2 and 4, which included components (A), (C), (D), and (E), curing was carried out while left to stand for 24 hours or more in an evaluation temperature atmosphere, with sufficient storage stability not obtained.

1. A room temperature curable organopolysiloxane composition, comprising:
(A) 100 parts by weight of a diorganopolysiloxane blocked at a molecular terminal with a hydroxysilyl group having a viscosity of from 20 to 1,000,000 mPa·s at 25° C.;
(B) 50 to 200 parts by mass of a diorganopolysiloxane blocked at a molecular terminal with an alkoxysilyl group having a viscosity of from 20 to 1,000,000 mPa·s at 25° C., per 100 parts by mass of component (A);
(C) a functional filler;
(D) 0.1 to 30 parts by mass of a compound having two or more alkoxy groups bonded to a silicon atom per molecule; and
(E) a catalytic amount of a catalyst for a condensation reaction;
further comprising at least the following liquids (I) and (II), which are individually stored,
wherein liquid (I) contains components (A) and (C), but does not contain components (B) and (E),
while liquid (II) contains components (B), (C), (D), and (E), but does not contain component (A).

2. The room temperature curable organopolysiloxane composition according to claim 1, wherein component (D) is a compound selected from the following components (d1) to (d3):
(d1) a silicon compound represented by general formula (1):
Si(OR¹)ₙR²₄₋ₙ (1)
where n is 2, 3, or 4, R¹ is an alkyl group, and R² is an organic group, or a hydrolyzed condensate thereof;
(d2) an organic compound having at least two alkoxysilyl groups per molecule, in addition to containing a bond other than a silicon-oxygen bond between these silyl groups; and
(d3) a reaction mixture between an amino group-containing organoalkoxysilane and an epoxy group-containing organoalkoxysilane.

3. The room temperature curable organopolysiloxane composition according to claim 1, which is a two-liquid type.

4. A protectant or adhesive composition of electric/electronic parts, comprising the room temperature curable organopolysiloxane composition according to claim 1.

5. Electric/electronic equipment, wherein electric/electronic parts thereof are formed by encapsulating or sealing a cured product of the room temperature curable organopolysiloxane composition according to claim 1.
